(19) United States
(12) Patent Application Publication
(10) Pub. No.: US 2025/0286880 A1
(43) Pub. Date: Sep. 11, 2025

(54) CERTIFICATE-BASED IDENTITY VERIFICATION FOR WIRELESS COMMUNICATION

(71) Applicant: Microsoft Technology Licensing, LLC, Redmond, WA (US)

(72) Inventor: Ravi Kanth KAJA, Hyderabad (IN)

(73) Assignee: Microsoft Technology Licensing, LLC, Redmond, WA (US)

(21) Appl. No.: 18/599,453

(22) Filed: Mar. 8, 2024

(51) Int. Cl. H04L 9/40; H04W 12/08; H04W 12/60

(52) U.S. Cl. CPC H04L 63/0823; H04W 12/66; H04W 12/08

(57) ABSTRACT

Aspects of the present disclosure relate to certificate-based identity verification for wireless communication. In examples, a wireless network has an associated certificate, such that the certificate may be validated to verify the identity of an establishment associated with the wireless network (e.g., prior to, when, and/or after establishing a connection with the wireless network). For instance, the certificate includes the name of the wireless network as the common name to which the certificate is bound. The certificate may automatically be validated and/or manually inspected by a user, thereby confirming that the corresponding wireless network is actually associated with the establishment. By contrast, a fraudulent wireless network may not have an associated certificate or may have a certificate that does not have a valid chain of trust, such that a computing device and/or a user may more easily distinguish between an authentic wireless network and a fraudulent wireless network.

### BACKGROUND

In examples, a wireless communication network enables communication by one or more computing devices. However, in instances where there are multiple wireless networks available (e.g., from which a user can choose), it may be difficult to verify the identity associated with a given wireless network. For instance, if an establishment makes a wireless network available for use by computing devices of its patrons, it may be difficult to discern the wireless network of the establishment from a fraudulent wireless network that is configured to appear similar and thus trick unsuspecting users into using the fraudulent wireless network instead of the establishment's wireless network.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to certificate-based identity verification for wireless communication. In examples, a wireless network has an associated certificate, such that the certificate may be validated to verify the identity of an establishment associated with the wireless network (e.g., prior to, when, and/or after establishing a connection with the wireless network). For instance, the certificate includes the name of the wireless network as the common name to which the certificate is bound. The certificate may automatically be validated and/or manually inspected by a user, thereby confirming that the corresponding wireless network is actually associated with the establishment. By contrast, a fraudulent wireless network may not have an associated certificate or may have a certificate that does not have a valid chain of trust, such that a computing device and/or a user may more easily distinguish between an authentic wireless network and a fraudulent wireless network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which certificate-based identity verification for wireless communication may be performed according to aspects of the present disclosure.

FIG. 2A illustrates an overview of an example method for evaluating available wireless networks according to aspects described herein.

FIG. 2B illustrates an overview of an example process flow between a computing device, a wireless network, and a certificate manager according to aspects described herein.

FIG. 3 illustrates an overview of an example method for automatically establishing a wireless connection based on a trusted certificate according to aspects described herein.

FIG. 4A illustrates an overview of an example chain of trust for a wireless network certificate according to aspects described herein.

FIG. 4B illustrates an overview of an example user interface for viewing available wireless networks according to aspects described herein.

FIG. 4C illustrates an overview of an example user interface for inspecting a certificate of a wireless network according to aspects of the present disclosure.

FIG. 5 is a block diagram illustrating example physical components of a computing device with which aspects of the disclosure may be practiced.

FIG. 6 is a simplified block diagram of a computing device with which aspects of the present disclosure may be practiced.

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user configures a computing device to communicate via a wireless communication network, for example by selecting the wireless network from a list of available wireless networks. However, it may be possible for the user to inadvertently select a different wireless network than the network to which the user intends to connect, as may be the case when a fraudulent wireless network is configured to have a network name that is similar to the user's intended wireless network. For instance, an attacker may target a publicly available wireless network (e.g., a legitimate network of an establishment, such as a company, a hotel, an airport, a conference center, or a café), such that a user may unintentionally connect to the attacker's wireless network instead of the legitimate wireless network. As a result, the attacker may be able to monitor network traffic and/or deliver malware to the user's computing device, among other examples.

Additionally, while mechanisms exist with which to protect a user from potential wireless network-related threats, such mechanisms may involve a tedious user experience, provide reduced protection, and/or require advanced technical knowledge by the user, among other detriments. For example, establishing a connection to a virtual private network (VPN) may still expose the computing device to potential threats between when the wireless network connection is established and when the VPN connection is established. As another example, the user may forego using a publicly available wireless network in favor of a personal wireless hotspot, though that may entail additional expense and/or planning by the user, and may also have limited utility in instances when poor cellular reception is available to the wireless hotspot.

Accordingly, aspects of the present disclosure relate to certificate-based identity verification for wireless communication. As an example, a wireless network of an establishment has an associated certificate, such that the certificate is validated to verify the identity of the wireless network (e.g., prior to, when, and/or after establishing a connection with the wireless network). For instance, the certificate includes the name of the wireless network (e.g., the service set identifier, or SSID) as the common name to which the certificate is bound.

In other examples, the common name need not include the exact network name, as may be the case when the common name includes a uniform resource locator (URL) or uniform resource identifier (URI), among other examples, from which the wireless network name is instead derived (e.g., “www.example.com” for a wireless network named “Example” or “city-location.example.com” for a wireless network named “Example-City Location”). It will be appreciated that any of a variety of algorithms and/or pattern matching techniques may be used to process such a common name accordingly.

A certificate may automatically be validated (e.g., based on determining that the certificate has been signed by a trusted certificate authority) and/or manually inspected by a user, thereby confirming that the corresponding wireless network is actually associated with the establishment. By contrast, a fraudulent wireless network may not have an associated certificate or may have a certificate that does not have a valid chain of trust. Thus, if the wireless network does not have an associated certificate or the certificate provided by the wireless network is determined to be invalid, it may be determined not to connect to the wireless network or to subject the wireless network to additional scrutiny (e.g., automatically according to an allow/deny list and/or manually by a user), among other examples.

In examples, the certificate that is associated with a wireless network (also referred to herein as a “wireless network certificate”) is part of a certificate chain, where a certificate authority acts as a trusted third party that signs a subsequent certificate (e.g., of the establishment) in the chain. For instance, the certificate authority validates the identity of the establishment (e.g., via identify verification or using proof of domain ownership) as a precondition for signing that establishment's certificate. In examples, the signed certificate thus includes verified information corresponding to the establishment, which may later be inspected (e.g., automatically and/or by a user). The signed certificate of the establishment may permit the establishment to operate as an intermediate certificate authority, such that the establishment may then issue a subsequent certificate in the chain of trust (e.g., a wireless network certificate). In other examples, the signed certificate of the establishment is itself a wireless network certificate.

It will therefore be appreciated that a chain of trust according to aspects described herein may have any of a variety of structures. For example, a root certificate authority issues an intermediate certificate to an establishment (e.g., an “intermediate establishment certificate”), which in turn is used to issue intermediate certificates according to various geographic regions (e.g., a set of “intermediate region certificates”). Each of intermediate region certificate may then ultimately be used to sign wireless network certificates (e.g., leaf certificates) that are each associated with a location within the corresponding geographic region. Any number of intermediate certificate authorities may thus be used according to aspects described herein.

In some instances, a specific certificate in the chain of trust is indicated as a trusted certificate (or a “trusted node” within the chain of trust), such that a connection to a wireless network having a certificate that depends therefrom is automatically established. For example, a user may indicate that an intermediate region certificate or an intermediate establishment certificate is a trusted certificate, thereby permitting the user's computing device to automatically connect to wireless networks associated with that establishment within a corresponding region or to wireless networks of the establishment in general, among other examples. In another example, a policy applied to a computing device specifies such a trusted certificate, thereby configuring the device automatically establish such wireless connections accordingly.

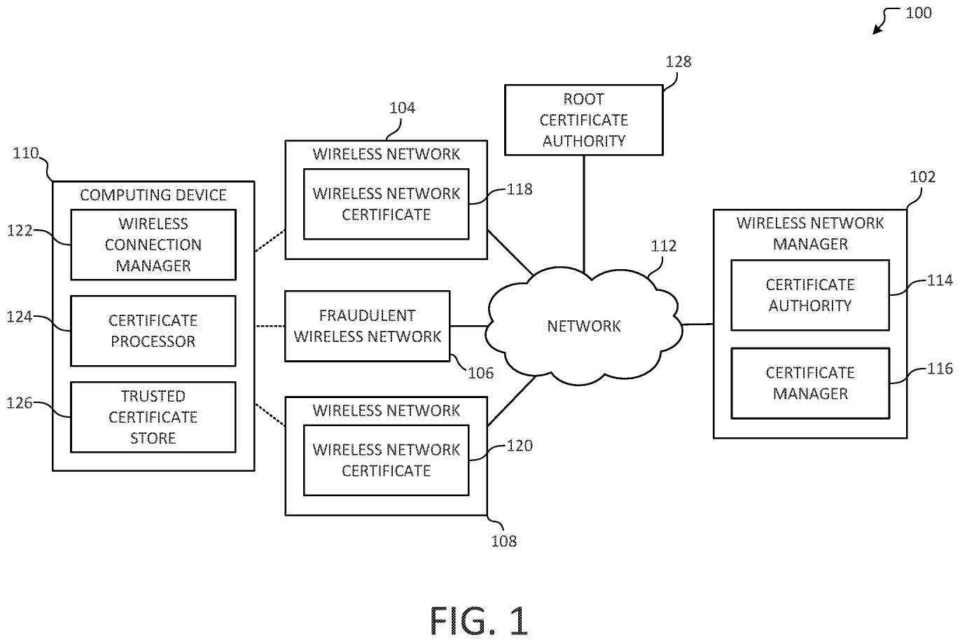

FIG. 1 illustrates an overview of an example system 100 in which certificate-based identity verification for wireless communication may be performed according to aspects of the present disclosure. As illustrated, system 100 includes wireless network manager 102, wireless network 104, fraudulent wireless network 106, wireless network 108, computing device 110, network 112, and root certificate authority 128. In examples, wireless network manager 102, wireless network 104, fraudulent wireless network 106, wireless network 108, computing device 110, and root certificate authority 128 communicate via network 112, which may comprise a local area network, a wireless network, or the Internet, or any combination thereof, among other examples.

As illustrated, wireless network manager 102 includes certificate authority 114 and certificate manager 116. In examples, wireless network manager 102 is associated with an establishment and manages one or more wireless networks (e.g., wireless network 104 and 108) of the establishment accordingly. While system 100 is illustrated as including a single wireless network manager 102 and two wireless networks 104 and 108, it will be appreciated that any number of such elements may be included in other examples. For example, an establishment-level wireless network manager may be used to manage multiple regional wireless network managers, among other examples.

Certificate authority 114 of wireless network manager 102 is an intermediate certificate authority, for example as may have been signed by root certificate authority 128 (e.g., after root certificate authority 128 verifies the identity of the establishment associated with wireless network manager 102). While system 100 is illustrated as including root certificate authority 128, it will be appreciated that, in other examples, a wireless network manager acts as its own root certificate authority (e.g., as may be the case when it is added as a trusted certificate authority to a device, for example as part of a provisioning profile).

Accordingly, certificate manager 116 uses certificate authority 114 to sign wireless network certificates 118 and 120, thereby enabling computing device 110 to verify the identity of wireless network 104 and wireless network 108, respectively, as being associated with the establishment. As another example, certificate manager 116 generates (e.g., signs) an intermediate certificate, which may thus be distributed to another wireless network manager, such that the other wireless network manager generates and distributes a wireless network certificate for a wireless network accordingly. It will therefore be appreciated that any number of tiers may be used to form a hierarchy of wireless networks/wireless network managers corresponding to a chain of trust according to aspects described herein.

Certificate manager 116 may additionally, or alternatively, be responsible for managing certificate renewal and/or certificate revocation. For example, wireless network certificates may expire after a predetermined amount of time and/or may be revoked (e.g., if it is determined they are no longer secure), such that wireless network manager 102 facilitates the generation of a new wireless network certificate and distribution thereof.

Computing device 110 is illustrated as comprising wireless connection manager 122, certificate processor 124, and trusted certificate store 126. In examples, wireless connection manager 122 scans for available wireless networks (e.g., one or more of wireless network 104, fraudulent network 106, and wireless network 108). For example, the wireless networks may each be a wireless network conforming to the IEEE 802.11 technical standard (e.g., Wi-Fi), though it will be appreciated that any of a variety of additional or alternative wireless network technologies (e.g., Bluetooth or a cellular network) may similarly be used in other examples.

As illustrated, wireless network 104 and wireless network 108 each have an associated wireless network certificate 118 or 120, respectively, whereas fraudulent wireless network 106 does not have an associated certificate. In other examples, a fraudulent wireless network may have an associated certificate, which, for example, fails validation and/or has a common name that does not correspond to its network name, among other examples.

Accordingly, certificate processor 124 obtains wireless network certificates for each of the identified wireless networks where available. In examples, certificate processor 124 automatically validates an obtained wireless network certificate, for example by validating a corresponding chain of trust and/or confirming that the common name of the wireless certificate matches the name of the wireless network, among other examples. Computing device 110 is further illustrated as including trusted certificate store 126, which may be maintained by certificate processor 124. For instance, trusted certificate store 126 includes a set of trusted certificate authorities and/or a revocation list against which certificates may be checked to determine whether a wireless network certificate has been revoked.

In examples, certificate processor 124 provides an indication of an automatic validation result to wireless connection manager 122. Accordingly, wireless connection manager 122 may thus automatically connect to a wireless network (e.g., if validation is successful and the network is known and/or if a node in the chain of trust has been marked as trusted for automatic connection) or prevent connection to a wireless network (e.g., if validation failed), among other examples.

Additionally, or alternatively, wireless connection manager 122 enables manual inspection of certificates by a user of computing device 110. For instance, wireless connection manager 122 displays a list of available wireless networks, where each network that has an available certificate is displayed in conjunction with a certificate indicator. User actuation of the indicator may thus enable the user to manually inspect the certificate, such that the user may determine whether the certificate and, thus, the wireless network is authentic. Accordingly, the user may provide user input to connect to the wireless network if the user decides the identity of the wireless network is verified. Additionally, or alternatively, the user indicates that a node of the chain of trust is to be trusted, thereby permitting automatic connection to other wireless networks sharing the same node.

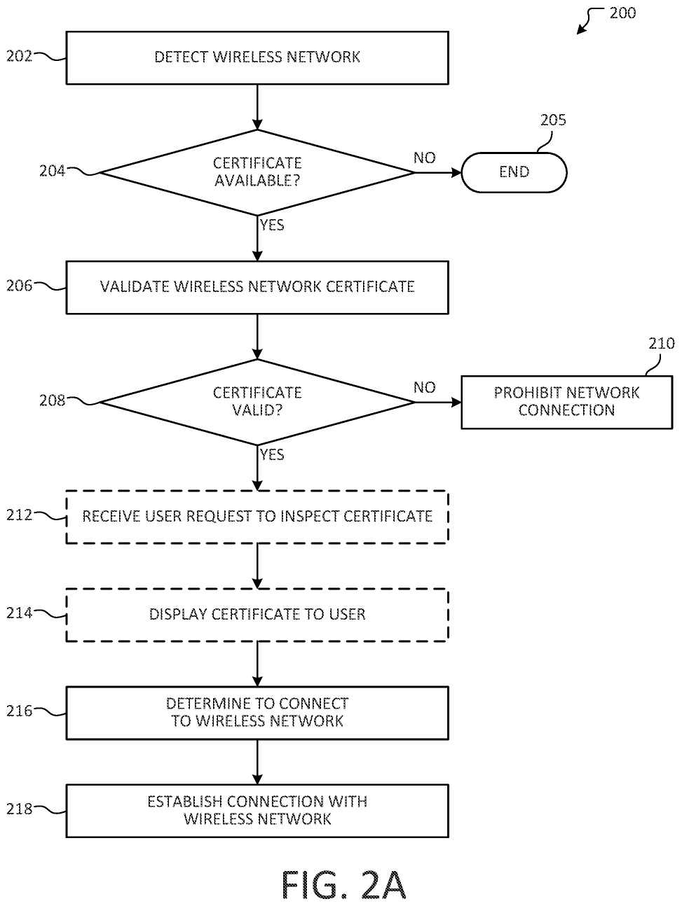

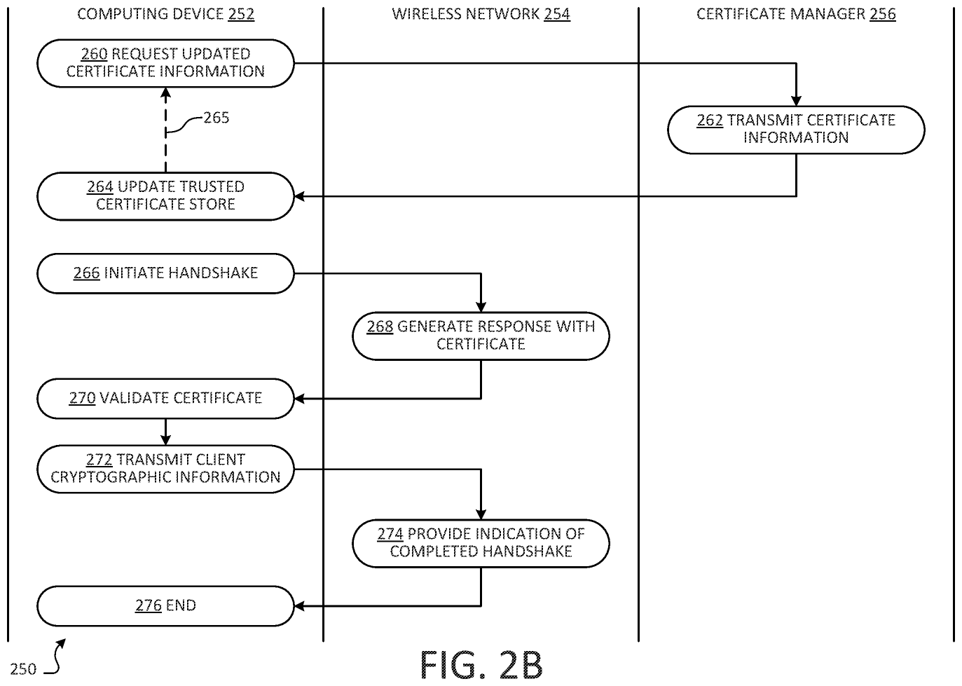

FIG. 2A illustrates an overview of an example method 200 for evaluating available wireless networks according to aspects described herein. In examples, aspects of method 200 are performed by a computing device (e.g., computing device 110 in FIG. 1).

As illustrated, method 200 begins at operation 202, where a wireless network (e.g., networks 104, 106, and/or 108 in FIG. 1) is detected. In examples, method 200 is performed periodically, as a result of the occurrence of an event (e.g., powering on a computing device or waking the device from sleep), or in response to a user indication to search for networks, among other examples. Method 200 is described with respect to a single wireless network, but it will be appreciated that, in other examples, similar aspects may be used in instances with multiple wireless networks.

At determination 204, it is determined whether a certificate is available for the detected network. For example, determination 204 comprises attempting to initiate a handshake with the wireless network, such that a failed handshake (e.g., one that is rejected or that times out) may be determined to indicate that a certificate is not available. Conversely, receipt of a response to such a handshake may thus indicate a certificate is available, and the response may itself include a wireless network certificate. It will be appreciated that any of a variety of other techniques may be used to determine whether a certificate is available. For example, the wireless network may include an indication in a beacon corresponding to the wireless network that a certificate is available, among other examples.

If it is determined that a certificate is not available, flow branches “NO” and terminates at operation 205. It will be appreciated that any of a variety of other operations may be performed as a result of determining that a certificate is not available. For instance, the network may still be included in a list for selection by a user, where an alert may be presented that the identity of the network could not be verified prior to establishing a connection. Additionally, or alternatively, a connection may automatically be established with the wireless network, as may be the case when the network is stored in a list of known networks.

If it is instead determined that a certificate is available, flow instead branches “YES” to operation 206, where the certificate is validated. For example, a chain of trust for the certificate is evaluated to determine whether a trusted root certificate authority is present in the chain and that subsequent signatures within the chain are similarly valid. Additionally, or alternatively, the certificate may be compared to a revocation list to determine whether the wireless network certificate has been revoked. As another example, operation 206 comprises comparing a network name to a common name indicated by the wireless network certificate. As noted above, the match may be exact or the common name may be processed to derive a name with which to compare the wireless network name. It will therefore be appreciated that any of a variety of validation techniques may be used according to aspects described herein.

At determination 208, it is determined whether operation 206 indicated that the certificate is valid. If the certificate is determined not to be valid, flow branches “NO” and terminates at operation 210, where the network connection is prohibited. In examples, operation 210 comprises omitting the wireless network from a list of wireless networks or displaying the wireless network as being “greyed out” or un-selectable, among other examples. Similar to operation 205, it will be appreciated that any of a variety of other operations may be performed as a result of determining the certificate is invalid. For instance, a warning may be presented, such that the user may still override the warning and connect to the wireless network anyway.

If it is instead determined that the certificate is valid, flow branches “YES” to operation 212, where a user request to inspect the certificate is received. For example, the user may actuate a certificate indicator associated with the wireless network, thereby causing the certificate to be displayed to the user at operation 214. Operations 212 and 214 are illustrated using dashed boxes to indicate that, in other examples, they may be omitted, as may be the case when method 200 automatically establishes a connection with the wireless network.

Thus, in other examples, flow may instead progress directly from determination 208 to operation 216, where it is determined to connect to the wireless network. In instances where flow arrives at operation 216 via operations 212 and 214, operation 216 may comprise receiving user input indicating a request to connect to the wireless network. In other examples, operation 216 comprises determining the wireless network is present in a list of known wireless networks and/or identifying a node in the chain of trust that has been indicated as trusted, such that the presence of that node causes a connection to be established with the wireless network automatically.

Accordingly, at operation 218, a connection is established with the wireless network. In examples, the connection is established by completing a handshake that was initiated at determination 204 to obtain the certificate of the server (e.g., according to Wi-Fi Protected Access 3 and the Extensible Authentication Protocol), thereby establishing an encrypted communication channel between the computing device and the wireless network. It will be appreciated that any of a variety of additional or alternative techniques may be used to establish a connection to the wireless network, as may be the case when a different communication technology is used. As illustrated, method 200 terminates at operation 218.

FIG. 2B illustrates an overview of an example process flow 250 between computing device 252, wireless network 254, and certificate manager 256 according to aspects described herein. Aspects of wireless network 254, and certificate manager 256 may be similar to those discussed above with respect to computing device 110, wireless networks 104/108, and certificate manager 116, respectively, in FIG. 1 and are therefore not necessarily redescribed in detail.

As illustrated, flow 250 begins at operation 260, where updated certificate information is requested. As noted above, a set of trusted certificate authorities and/or a revocation list may be maintained by a computing device. Accordingly, certificate manager 256 processes the request at operation 262, such that a trusted certificate store (e.g., trusted certificate store 126 in FIG. 1) is updated accordingly. Arrow 265 is provided to illustrate that flow may loop between operations 260, 262, and 264 to maintain an updated trusted certificate store with which wireless networks may be verified according to aspects described herein.

As another example, operations 262 and 264 additionally, or alternatively, comprise obtaining one or more intermediate certificates from certificate manager 256. The intermediate certificates may be processed at operation 264 to determine whether an associated chain of trust is valid (e.g., based on a root certificate of the certificate store), at which point the intermediate certificates are stored within the certificate store accordingly.

At operation 266, a handshake is initiated with wireless network 254. In examples, operations 266-276 may occur contemporancously with and/or separately from operations 260-264 discussed above. Aspects of operation 266 may be similar to those discussed above with respect to determination 204 of FIG. 2A, where a handshake is initiated with a wireless network (e.g., wireless network 254) so as to obtain a wireless network certificate associated therewith. In examples, operation 266 comprises providing a protocol version (e.g., a Transport Security Layer (TLS) version), a list of available cipher suites, and/or a cryptographic nonce for use in session creation, among other examples.

Accordingly, at operation 268, wireless network 254 generates a response to the handshake initiation by computing device 252. In examples, the response comprises a wireless network certificate associated with wireless network 254 according to aspects described herein. In some examples, the response comprises a protocol version, a list of available cipher suites, and/or a cryptographic nonce, among other examples. In some examples, the response comprises a public key associated with the wireless network, thereby enabling subsequent communication from computing device 252 to wireless network 254 to be encrypted accordingly.

As another example, operation 270 comprises obtaining a set of intermediate certificates in addition to the wireless network certificate. Such certificates may be obtained from wireless network 254 and/or certificate manager 256, among other examples. In such an example, operations 260, 262, and 264 may be omitted, as computing device 252 need not maintain a certificate store with such certificates. As another example, operations similar to operations 260, 262, and 264 may still be performed, for example to maintain a certificate revocation list.

In examples, Online Certificate Status Protocol (OCSP) stapling is additionally, or alternatively, used, as may be beneficial in instances where a certificate store of the computing device is outdated. In such an example, the response generated at operation 268 further comprises a signed OCSP indication (e.g., as may be signed by a root and/or intermediate certificate authority), thereby enabling computing device 252 to validate the wireless network certificate based on the OCSP indication accordingly at operation 270.

Flow progresses to operation 270, where the certificate received from wireless network 254 is validated. Aspects of operation 270 may be similar to those discussed above with respect to operations 206 and 208 in FIG. 2A and are therefore not necessarily redescribed in detail. Accordingly, once the certificate is validated, client cryptographic information is transmitted from computing device 252 to wireless network 254 in operation 272. Example client cryptographic information includes, but is not limited to, a public key of computing device 252, an indication to encrypted subsequent communications, and/or an indication that the client-side portion of the handshake is complete, which may be encrypted (e.g., using the public key that was provided by wireless network 254 at operation 268). In some instances, the communication from computing device 252 includes a symmetrical cryptographic key (e.g., encrypted using the public key of wireless network 254), which may thus be used for subsequent communication (e.g., after it is decrypted by wireless network 254).

Accordingly, at operation 274, wireless network 254 similarly provides an indication that the server-side portion of the handshake is complete. In examples, the indication additionally, or alternatively, comprises a confirmation that subsequent messages will be encrypted. As a result, computing device 252 was able to verify the identity of wireless network 254 in addition to establishing an encrypted communication channel for subsequent communication between computing device 252 and wireless network 254. As illustrated, flow 250 ends at operation 276.

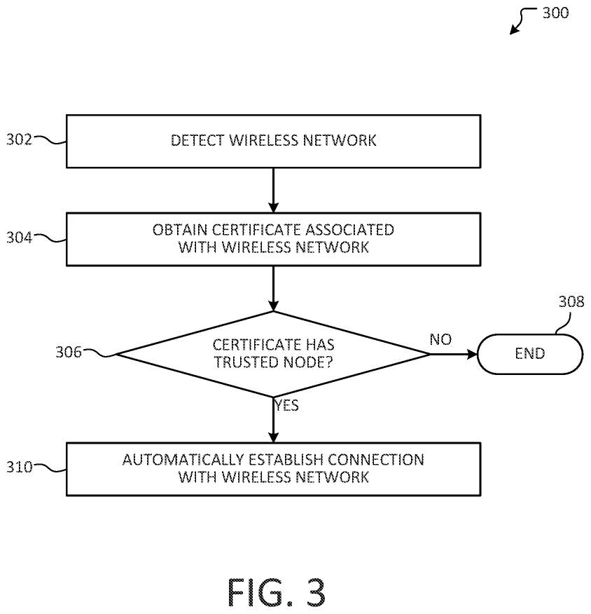

FIG. 3 illustrates an overview of an example method 300 for automatically establishing a wireless connection based on a trusted certificate according to aspects described herein. In examples, aspects of method 300 are performed by a computing device (e.g., computing device 110 in FIG. 1).

As illustrated, method 300 begins at operation 302, where a wireless network is detected. Aspects of operation 302 may be similar to those discussed above with respect to operation 202 and are therefore not necessarily redescribed in detail. In examples, the wireless network detected at operation 302 has an associated wireless network certificate, thereby enabling wireless network identity verification according to aspects described herein.

At operation 304, a wireless network certificate associated with the wireless network is obtained. Aspects of operation 304 may be similar to those discussed above with respect to determination 204 and are therefore not necessarily redescribed in detail. Accordingly, at operation 306, it is determined whether a chain of trust for the certificate includes a trusted node (e.g., as may have been indicated by a user, for example as a user preference, or via a provisioning profile). For instance, the trusted node may be a node other than the root certificate authority, such as an establishment regional certificate authority or an intermediate regional certificate authority, among other examples.

If it is determined that the chain of trust of the certificate does not include such a trusted node, flow branches “NO” and ends at operation 308. It will be appreciated that any of a variety of other operations may be performed, similar to those discussed above with respect to FIGS. 2A and 2B where a network connection is established (e.g., as a result of user input selecting the wireless network).

However, if it is instead determined that the chain of trust of the certificate includes a trusted now, flow branches “YES” and terminates at operation 310, where a connection is automatically established with the wireless network. Aspects of operation 310 are similar to those discussed above with respect to operation 218 and are therefore not necessarily redescribed in detail.

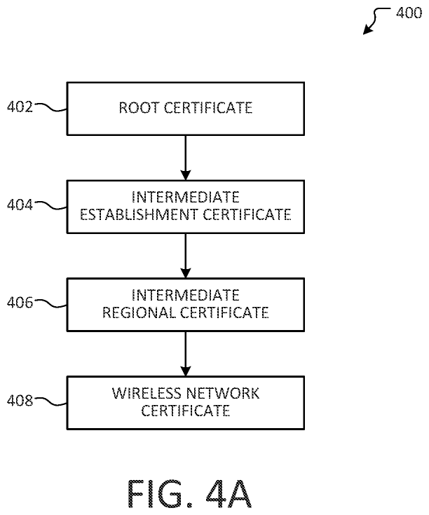

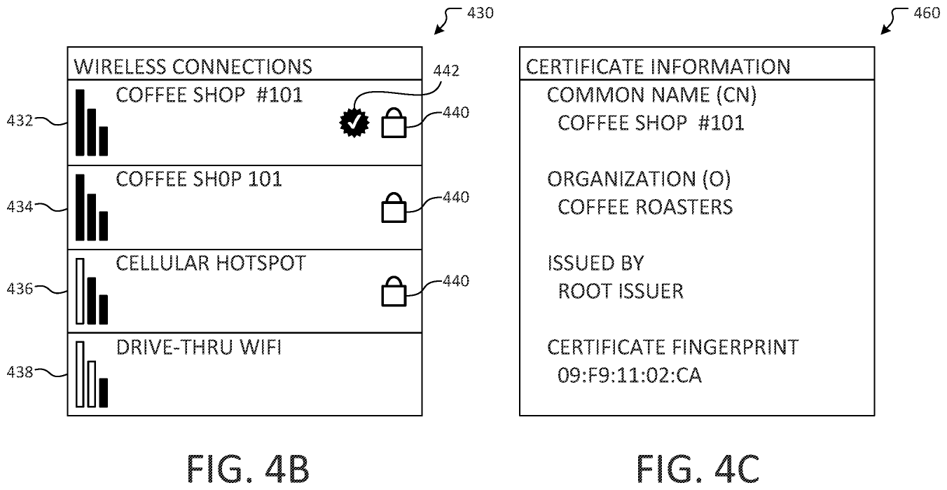

FIG. 4A illustrates an overview of an example chain of trust 400 for a wireless network certificate according to aspects described herein. As illustrated, chain of trust 400 includes root certificate 402, intermediate establishment certificate 404, intermediate regional certificate 406, and wireless network certificate 408. Root certificate 402 may be that of a trusted root certificate authority, which has thus verified the identity of an establishment associated with intermediate establishment certificate 404. Thus, as a result of a computing device trusting root certificate 402, trust is extended to intermediate establishment certificate 404.

Similarly, intermediate regional certificate 406 has been signed by intermediate establishment certificate 404, thereby further extending the chain of trust from root certificate 402 to intermediate regional certificate 406 via intermediate establishment certificate 404. Finally, wireless network certificate 408 is a leaf certificate (rather than an intermediate certificate, as was the case with certificates 404 and 406), which has been signed by intermediate regional certificate 406 accordingly. Trust is therefore further extended to wireless network certificate 408, thereby permitting the entire chain of trust 400 to be validated accordingly.

As noted above, a node of chain of trust 400 may be indicated as a trusted node (e.g., intermediate establishment certificate 404 and/or intermediate regional certificate 406), such that wireless network certificate 408 and other wireless network certificates sharing that same node are trusted. As described herein, such aspects may thus facilitate automatic connection to a corresponding wireless network accordingly.

FIG. 4B illustrates an overview of an example user interface 430 for viewing available wireless networks according to aspects described herein. As illustrated, user interface 430 includes wireless network list entries 432, 434, 436, and 438. Additionally, wireless network entries 432, 434, and 436 are illustrated in association with encryption indicator 440, thereby indicating to a user that the corresponding wireless networks are protected by encryption. However, encryption indicator 440 makes no indication as to the identity validity for a given wireless network.

By contrast, certificate indicator 442 provides an indication to a user that the wireless network “COFFEE SHOP #101” has an accompanying wireless network certificate that has been validated according to aspects described herein. It will be appreciated that any of a variety of additional or alternative indicators may be provided in other examples. For instance, a certificate indicator need not include a checkmark and may instead indicate the presence of a certificate (rather than a certificate that has been validated). Additionally, or alternatively, an indicator may be provided that indicates that validation failed (or that the certificate is valid but for its expiration date).

FIG. 4C illustrates an overview of an example user interface 460 for inspecting a certificate of a wireless network according to aspects of the present disclosure. In examples, user interface 460 is displayed as a result of a user actuating certificate indicator 442 discussed above with respect to FIG. 4B. It will be appreciated that user interface 460 includes example certificate information and, in other examples, any of a variety of additional or alternative certificate information may be presented. For instance, user interface 460 may additionally or alternatively include an indication of an expiration date of the certificate and/or an accompanying chain of trust (such that a user may select a node of the chain of trust to enable the automatic network connection aspects described herein).

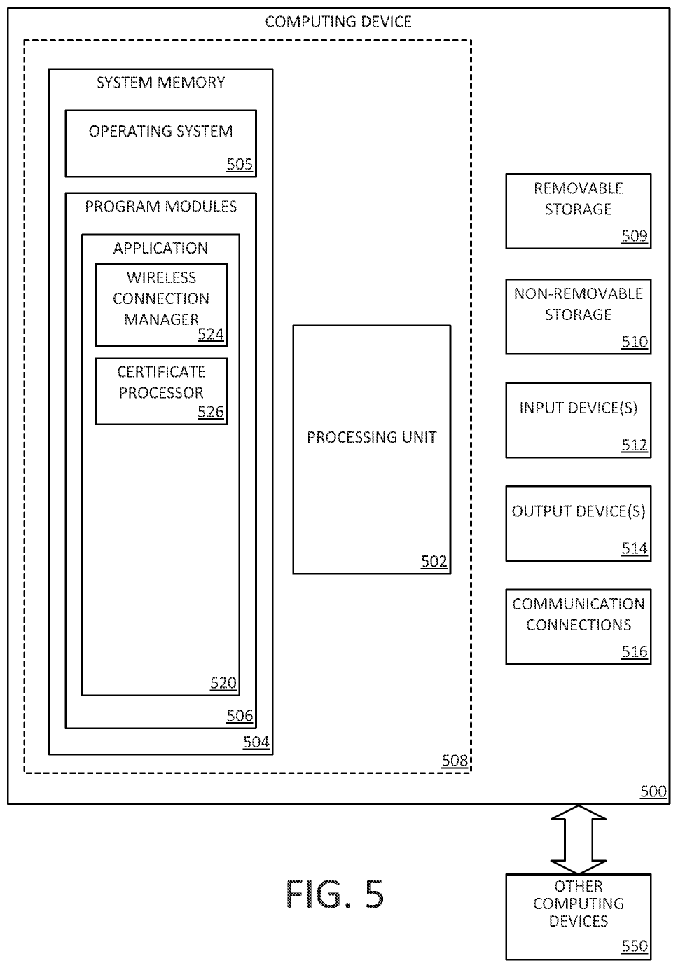

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with wireless network manager 102, root certificate authority 128, wireless networks 104, 106, and/or 108, as well as computing device 110 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may include wireless connection manager 524 and certificate processor 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically crasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

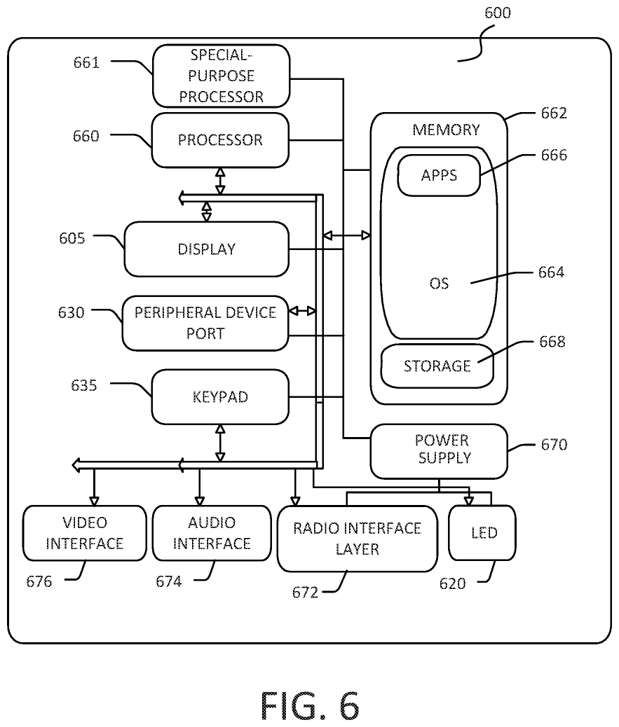

FIG. 6 illustrates a system 600 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some embodiments. In another example, an optional keypad 635 may also be included, which may be a physical keypad or a “soft” keypad generated on the touch screen display.

In various embodiments, the output elements include the display 605 for showing a graphical user interface (GUI), a visual indicator (e.g., a light emitting diode 620), and/or an audio transducer (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein.

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer. In the illustrated embodiment, the visual indicator 620 is a light emitting diode (LED) and the audio transducer is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

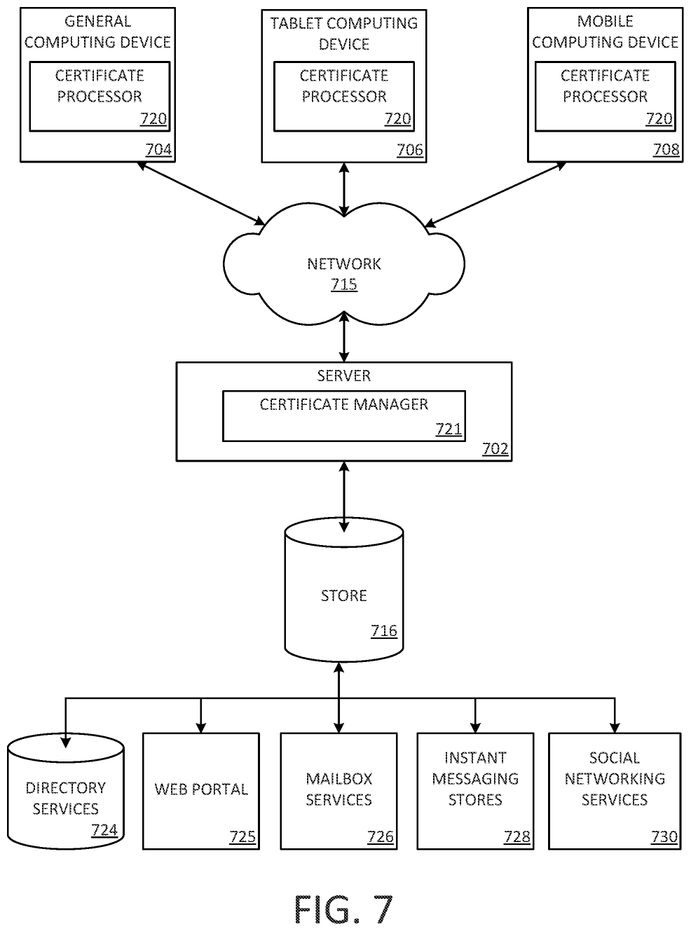

FIG. 7 illustrates one aspect of the architecture of a system for processing data received at a server from another computing device, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

A certificate processor 720 may be employed by a client that communicates with server device 702. Additionally, or alternatively, certificate manager 721 may be employed by server device 702 (e.g., similar to wireless network manager 102 discussed above with respect to FIG. 1). The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: detecting a wireless network available for communication by the system; obtaining a wireless network certificate associated with the wireless network; evaluating a chain of trust of the wireless network certificate to validate the wireless network certificate, wherein the wireless network certificate includes a common name that corresponds to a network name of the wireless network; and based on validating the wireless network certificate, establishing a connection with the wireless network. In an example, the chain of trust includes a node associated with an establishment; and validating the wireless network certificate thereby validates an association between the wireless network and the establishment. In another example, the node associated with the establishment corresponds to an intermediate establishment certificate; and the chain of trust further includes an intermediate regional certificate signed by the intermediate establishment certificate. In a further example, obtaining the wireless network certificate comprises: initiating a handshake with the wireless network; and receiving, as a response of the handshake, the wireless network certificate. In yet another example, the set of operations further comprises: providing an indication that the wireless network certificate is valid; and receiving user input indicating a request to connect to the wireless network; and the connection with the wireless network is established further based on the received user input. In a further still example, the common name is an exact match for the network name of the wireless network. In an example, the set of operations further comprises: based on determining the wireless network certificate is not valid: prohibiting a connection with the wireless network; or displaying a warning for the wireless network.

In another aspect, the technology relates to a method for automatically connecting to a wireless network. The method comprises: obtaining a wireless network certificate associated with the wireless network; evaluating a chain of trust of the wireless network certificate, wherein the wireless network certificate includes a common name that corresponds to a network name of the wireless network; and based on identifying a trusted node of the wireless network certificate, establishing a connection with the wireless network. In an example, a root node of the chain of trust corresponds to a trusted root certificate authority; and the trusted node is a different node than the root node in the chain of trust. In another example, obtaining the wireless network certificate comprises: initiating a handshake with the wireless network; and receiving, as a response of the handshake, the wireless network certificate. In a further example, the common name is an exact match for the network name of the wireless network. In yet another example, the trusted node is defined as at least one of: a user preference; or as part of a provisioning profile. In a further still example, the chain of trust includes a node associated with an establishment, thereby validating an association between the wireless network and the establishment.

In a further aspect, the technology relates to a method for verifying an identity associated with a wireless network. The method comprises: detecting the wireless network; obtaining a wireless network certificate associated with the wireless network; evaluating a chain of trust of the wireless network certificate to validate the wireless network certificate, wherein the wireless network certificate includes a common name that corresponds to a network name of the wireless network; and based on validating the wireless network certificate, establishing a connection with the wireless network. In an example, the chain of trust includes a node associated with an establishment; and validating the wireless network certificate thereby validates an association between the wireless network and the establishment. In another example, the node associated with the establishment corresponds to an intermediate establishment certificate; and the chain of trust further includes an intermediate regional certificate signed by the intermediate establishment certificate. In a further example, obtaining the wireless network certificate comprises: initiating a handshake with the wireless network; and receiving, as a response of the handshake, the wireless network certificate. In yet another example, the method further comprises: providing an indication that the wireless network certificate is valid; and receiving user input indicating a request to connect to the wireless network; and the connection with the wireless network is established further based on the received user input. In a further still example, the common name is an exact match for the network name of the wireless network. In an example, the wireless network is a first wireless network; the wireless network certificate is a first wireless network certificate; and the method further comprises: detecting a second wireless network; obtaining a second wireless network certificate associated with the second wireless network; and based on determining the second wireless network certificate is not valid: prohibiting a connection with the second wireless network; or displaying a warning for the wireless network.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
detecting a wireless network available for communication by the system;
obtaining a wireless network certificate associated with the wireless network;
evaluating a chain of trust of the wireless network certificate to validate the wireless network certificate, wherein the wireless network certificate includes a common name that corresponds to a network name of the wireless network; and
based on validating the wireless network certificate, establishing a connection with the wireless network.

2. The system of claim 1, wherein:
the chain of trust includes a node associated with an establishment; and
validating the wireless network certificate thereby validates an association between the wireless network and the establishment.

3. The system of claim 2, wherein:
the node associated with the establishment corresponds to an intermediate establishment certificate; and
the chain of trust further includes an intermediate regional certificate signed by the intermediate establishment certificate.

4. The system of claim 1, wherein obtaining the wireless network certificate comprises:
initiating a handshake with the wireless network; and
receiving, as a response of the handshake, the wireless network certificate.

5. The system of claim 1, wherein:
the set of operations further comprises:
providing an indication that the wireless network certificate is valid; and
receiving user input indicating a request to connect to the wireless network; and
the connection with the wireless network is established further based on the received user input.

6. The system of claim 1, wherein the common name is an exact match for the network name of the wireless network.

7. The system of claim 1, wherein the set of operations further comprises:
based on determining the wireless network certificate is not valid:
prohibiting a connection with the wireless network; or
displaying a warning for the wireless network.

8. A method for automatically connecting to a wireless network, the method comprising:
obtaining a wireless network certificate associated with the wireless network;
evaluating a chain of trust of the wireless network certificate, wherein the wireless network certificate includes a common name that corresponds to a network name of the wireless network; and
based on identifying a trusted node of the wireless network certificate, establishing a connection with the wireless network.

9. The method of claim 8, wherein:
a root node of the chain of trust corresponds to a trusted root certificate authority; and
the trusted node is a different node than the root node in the chain of trust.

10. The method of claim 8, wherein obtaining the wireless network certificate comprises:
initiating a handshake with the wireless network; and
receiving, as a response of the handshake, the wireless network certificate.

11. The method of claim 8, wherein the common name is an exact match for the network name of the wireless network.

12. The method of claim 8, wherein the trusted node is defined as at least one of:
a user preference; or
as part of a provisioning profile.

13. The method of claim 8, wherein the chain of trust includes a node associated with an establishment, thereby validating an association between the wireless network and the establishment.

14. A method for verifying an identity associated with a wireless network, the method comprising:
detecting the wireless network;
obtaining a wireless network certificate associated with the wireless network;
evaluating a chain of trust of the wireless network certificate to validate the wireless network certificate, wherein the wireless network certificate includes a common name that corresponds to a network name of the wireless network; and
based on validating the wireless network certificate, establishing a connection with the wireless network.

15. The method of claim 14, wherein:
the chain of trust includes a node associated with an establishment; and
validating the wireless network certificate thereby validates an association between the wireless network and the establishment.

16. The method of claim 15, wherein:
the node associated with the establishment corresponds to an intermediate establishment certificate; and
the chain of trust further includes an intermediate regional certificate signed by the intermediate establishment certificate.

17. The method of claim 14, wherein obtaining the wireless network certificate comprises:
initiating a handshake with the wireless network; and
receiving, as a response of the handshake, the wireless network certificate.

18. The method of claim 14, wherein:
the method further comprises:
providing an indication that the wireless network certificate is valid; and
receiving user input indicating a request to connect to the wireless network; and
the connection with the wireless network is established further based on the received user input.

19. The method of claim 14, wherein the common name is an exact match for the network name of the wireless network.

20. The method of claim 14, wherein:
the wireless network is a first wireless network;
the wireless network certificate is a first wireless network certificate; and
the method further comprises:
detecting a second wireless network;
obtaining a second wireless network certificate associated with the second wireless network; and
based on determining the second wireless network certificate is not valid:
prohibiting a connection with the second wireless network; or
displaying a warning for the wireless network.
